(19) United States
(12) Patent Application Publication
(10) Pub. No.: US 2025/0335341 A1
(43) Pub. Date: Oct. 30, 2025

(54) NAVIGATION AUGMENTED TESTING

(71) Applicant: Microsoft Technology Licensing, LLC, Redmond, WA (US)

(72) Inventors: William Tigard BAKER, Redmond, WA (US); Timothy James CHAPMAN, Bellevue, WA (US); Jareth Leigh DAY, Sammamish, WA (US)

(73) Assignee: Microsoft Technology Licensing, LLC, Redmond, WA (US)

(21) Appl. No.: 18/650,890

(22) Filed: Apr. 30, 2024

(51) Int. Cl. G06F 11/36

(52) U.S. Cl. CPC G06F 11/3688; G06F 11/3684

(57) ABSTRACT

Navigation augmented testing (NAuT) of a software product under test. In examples, NAuT uses a testing agent to execute steps of a navigation augmented test. The navigation augmented test is a lightly scripted test where one or more steps may be condensed into a navigation instruction to navigate to a specified target element (e.g., a state where the target element is available and/or otherwise accessible for an interaction). According to examples, a navigation map is built from data collected in a previous random exploration testing run. The navigation map includes information about relationships between elements and/or actions performed on the elements and different pre- and post-action states. The testing agent uses the navigation map to determine a route including one or more steps for the testing agent to execute to produce a state where the specified target element is available and/or otherwise accessible for performing a subsequent action.

### BACKGROUND

Testing is a phase in software development that includes evaluating a software product to identify defects, errors, and/or discrepancies to ensure that the software product behaves as expected, meets its requirements, and functions correctly. Shifting testing and validation earlier in the software development lifecycle (e.g., sometimes referred to as “Shift Left Testing”) may promote quality by enabling early bug detection, informing better design, reducing development costs, improving efficiency, mitigating risks, and contributing to successful software delivery. Employing automated testing is a technique that can be implemented to shift testing and validation earlier in the software development process.

One example type of automated testing is scripted testing, where a scripted test specifies each step that a testing agent should take to validate an option/feature. Scripted tests are expensive to author and maintain. For instance, authoring a scripted test entails specifying every step to interact with a particular element of the software being tested. Once authored, additional costs are incurred in maintaining the scripted test. For instance, small product changes can break testing scripts and require that they be updated. Another example of automated testing is random exploration testing, where a random exploration test involves the testing agent operating in a continuous loop of inspecting a current state of the software under test (e.g., identifying user interface (UI) elements or other elements that may be interacted with and/or a type of interaction each element is able to receive), taking an action in association with an identified element, and observing a next state. Random/explorative testing provides benefits, such as reducing time and costs associated with authoring and maintaining tradition scripted tests; however random/exploration testing systems have non-deterministic behavior. Thus, traditional random/exploration testing cannot guarantee that particular scenarios of interest (e.g., important scenarios) will be exercised during testing.

It is with respect to these and other considerations that examples have been made. In addition, although relatively specific problems have been discussed, it should be understood that the examples should not be limited to solving the specific problems identified in the background.

### SUMMARY

The technology described herein provides a navigation augmented software-testing platform that tests software using navigation augmented testing. A navigation map is built using historical data from testing runs (e.g., a past random exploration testing run). In some examples, random exploration testing is performed on one or more instances of software under test, where a testing agent randomly performs different actions on elements of the software under test and observes how the state of the software under test changes. Data about the action taken on an element and data about conditions about a pre-action state (e.g., before the action is performed) and a post-action state (e.g., after the action is performed) are used to build the navigation map. For instance, the navigation map includes information about relationships between elements and conditions of different pre-and post-action states. Additionally, the navigation map includes information about relationships between actions performed on elements and conditions of different pre-and post-action states.

In examples, a navigation augmented test is scripted with steps for the testing agent to perform to test specific expected behavior of the software under test. The steps include one or a combination of a navigation instruction that specifies a target element to navigate to and/or an action instruction that specifies a target action to perform on a target element. In examples, the testing agent uses the navigation map to determine a route of one or more steps to perform to navigate to (e.g., produce conditions of) a desired state (e.g., a target state) of the software under test from an initial state (e.g., an observed current state). Example conditions of the target state correspond to the target element of the navigation instruction being visible, accessible, in a particular position, interactable (e.g., able to be engaged with), etc. In some examples, the testing agent further performs the one or more steps of the determined route to produce the target state. When conditions of the target state are satisfied, a subsequent action instruction may be executed by the testing agent to perform a target action. According to an aspect, navigation instructions allow for a lightweight test to be authored in comparison with a traditional scripted test that specifies each step that the testing agent should take. For instance, a test author would only need to specify a target element, while the navigation map is used to handle navigating to the correct state.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example by the accompanying figures, in which like references indicate similar elements. Elements in the figures are illustrated for simplicity and clarity and have not necessarily been drawn to scale.

FIG. 1 is a block diagram of an example software testing environment in which navigation augmented testing in software product testing may be implemented according to an aspect;

FIG. 2A is a diagram showing building a navigation map based on data collected in a first automated testing run according to an aspect;

FIG. 2B is a diagram showing using the navigation map built in FIG. 2A to determine steps for executing a navigation and/or action instruction included in a navigation augmented test according to an aspect;

FIG. 3 depicts a flow diagram depicting a first example method of executing a navigation augmented test according to an aspect;

FIG. 4 depicts a flow diagram depicting a second example method of executing a navigation augmented test according to an aspect;

FIG. 5 depicts a flow diagram depicting a third example method of executing a navigation augmented test according to an aspect;

FIG. 6 depicts a flow diagram depicting a fourth example method of executing a navigation augmented test according to an aspect;

FIG. 7 is a flow diagram depicting an example method of performing navigation augmented testing according to an aspect; and

FIG. 8 is a block diagram illustrating example physical components of a computing device with which aspects of the disclosure may be practiced.

### DETAILED DESCRIPTION

Aspects described herein provide navigation augmented testing (NAuT) of a software product under test. NAuT testing is performed to test success or failure of a user scenario (e.g., a specific expected behavior of the software under test in response to interacting with an element of the software). The element may be one of various types of elements, such as a user interface (UI) element, an application programming interface (API) function, a database object, or another interactive element of the software under test.

Information about various actions performed with various elements of the software under test, conditions associated with a state of the of the software under test (or a test machine that the software under test is operating on) prior to the actions being performed, and conditions associated with a state after the actions are performed in one or more previous random exploration testing runs is used to build a model (e.g., a navigation map). The navigation map includes information about relationships between elements and/or actions performed on the elements and different pre-and post-action states, which can be used to determine pre-and postconditions corresponding to different interactions.

In examples, NAuT further involves using a testing agent to execute steps of a navigation augmented test. The navigation augmented test is a lightly scripted test where one or more steps may be condensed into a navigation instruction to navigate to a specified target element (e.g., a state where the target element is available and/or otherwise accessible for an interaction). According to examples, the testing agent uses the navigation map to determine a route including one or more steps for the testing agent to execute to produce a state of the software under test where the specified target element is available and/or otherwise accessible for the interaction.

As an example, at least one step of a navigation augmented test includes a navigation instruction that specifies navigating to a target element (e.g., “Navigate to X”, where X is the target element). In executing the navigation instruction, the testing agent queries a navigation map for a route (e.g., one or more steps to perform) to navigate to a target state where the first target element is on screen or otherwise available for interaction from an observed current state. In some examples, the testing agent further performs the one or more steps of the route to navigate to the first target state.

In some examples, a same or subsequent step of the navigation augmented test includes an action instruction (e.g., “Click on X”) that specifies a target action to perform in association with the first target element (or another target element). In executing the navigation instruction, the testing agent uses the navigation map to determine a route (e.g., one or more steps to perform) to navigate to a target state where preconditions corresponding to interacting with the target element to perform the target action are met (e.g., “X” being on screen and/or otherwise available to be clicked/selected). When the target state is met (e.g., conditions observed in a current state matches the preconditions of the second target state), the testing agent further interacts with the target element to perform the target action. In some implementations, the action instruction and the navigation instruction are combined (e.g., “Navigate to ‘Click on Y’”, where ‘Click on Y’ is the target action and Y is the target element).

Validation may occur when a desired result of performing the target action (e.g., a goal state) occurs. Additionally, the desired result/outcome of performing a target action is defined by the goal state including a set of state conditions that reflect achieving the desired result/outcome. In one example, the desired result/outcome is related to an unhealthy state, such as a crash, a hang, an exception, an assertion error, or the surfacing of any error message. For instance, a target state may be implemented to recreate an error (e.g., as part of debugging). In another example, the desired result/outcome is related to a healthy state, such as a scenario completion (e.g., completion of a task within software being tested). That is, the target state may be a healthy state (e.g., verify a button functions as intended) or an unhealthy state (e.g., verify a button is not functioning as intended, as noted in a bug report).

According to an aspect, navigation instructions allow for a lightweight test to be authored in comparison with a traditional scripted test that specifies each step that the testing agent should take. As an example, a traditional scripted UI test may specify each of the following steps to validate a settings option is working as expected:
1. Click Start
2. Wait for Start menu to open
3. Scroll to Settings
4. Click Settings
5. Wait for Settings to Open
6. Click on Personalization
7. Click on Colors
8. Click on “Show accent color on title bars and windows borders”
9. Validate that title bar color has changed.

In contrast, rather than specifying each step that the testing agent should take to validate the option/feature, a navigation instruction included in a navigation augmented test leverages both an observed current state of the software product and what has been learned in one or more previous testing runs. For instance, a navigation augmented test may specify the following steps to validate the settings option of the above example, where the first step includes the navigation instruction and the second step includes an action instruction:
1. Navigate to “Personalization >Colors” in Settings
2. Click on “Show accent color on title bars and windows borders”
3. Validate that the title bar color has changed.

In examples, the testing agent uses the navigation map to determine the steps to reproduce a target state or to navigate from the observed current state to a target state where the target element “Personalization > Colors” in Settings is available for interaction (e.g., on screen and is not obscured). When conditions of the target state are satisfied, the subsequent action instruction may cause the testing agent to perform the target action (e.g., click on the target element “Show accent color on title bars and windows borders”).

As another example, a target state associated with a target action that involves emptying items from a shopping cart has a precondition that the shopping cart includes at least one item. Thus, navigating to the target state from an observed current state includes performing one or more steps of a route determined, using the navigation map, to produce conditions of the target state where the shopping cart has at least one item in it.

As yet another example, a target action that involves deleting a group of files having particular attributes (e.g., 5 files larger than 10 gigabytes (GB)) includes a precondition that a group of files having the particular attributes exists. Thus, navigating to the target state from an observed current state includes performing one or more steps of a route determined to produce the target state where a group of files have the particular attributes to perform the deletion.

In examples, the testing agent is able to navigate to/reproduce the target state without requiring the specific steps to be authored. As can be seen from the example above, a plurality of the steps included in the traditional scripted test (e.g., steps 1-7) can be reduced to a single navigation instruction (or a subset of navigation instructions) of a navigation augmented test. Authoring navigation augmented tests for testing software products reduces time and costs associated with authoring traditional scripted tests and is an improvement over random exploration tests that cannot guarantee that particular (e.g., important) scenarios are exercised during testing.

In further examples, the testing agent uses the navigation map to discover steps to navigate to a target state when pre-authored steps may be incorrect (e.g., due to an error or a change made to the software product or underlying operating system). Navigation augmented tests are therefore resilient to changes in the software product. For instance, if the software product's UI changes in the above example to where the UI element previously used to open Settings is moved from the Start menu to a task bar, a traditional scripted UI test may need to be updated to prevent the test from failing when the Settings UI element is not found in the Start menu during testing. In some cases, an error may occur or the test may fail when a target state cannot be reached, such as when a target element has been removed from the software under test. According to aspects, NAuT automatically adapts to changes (e.g., the UI change) by using the navigation map to discover a new route (i.e., the steps to Settings) and then use the new route to perform the target action.

In yet further examples, a route determined by using the navigation map is additionally used to determine and report testing results. For instance, a navigation augmented test in which a step is identified as incorrect and/or extraneous, but where a new route is discovered to the target state may cause the NAuT system to report a result of “succeeded” but “with warnings.” In yet further examples, the NAuT system provides a recommendation to update the navigation augmented test based on a discovered new route. In still yet further examples, the NAuT system automatically replaces steps in a scripted or navigation augmented test with steps of the discovered new route.

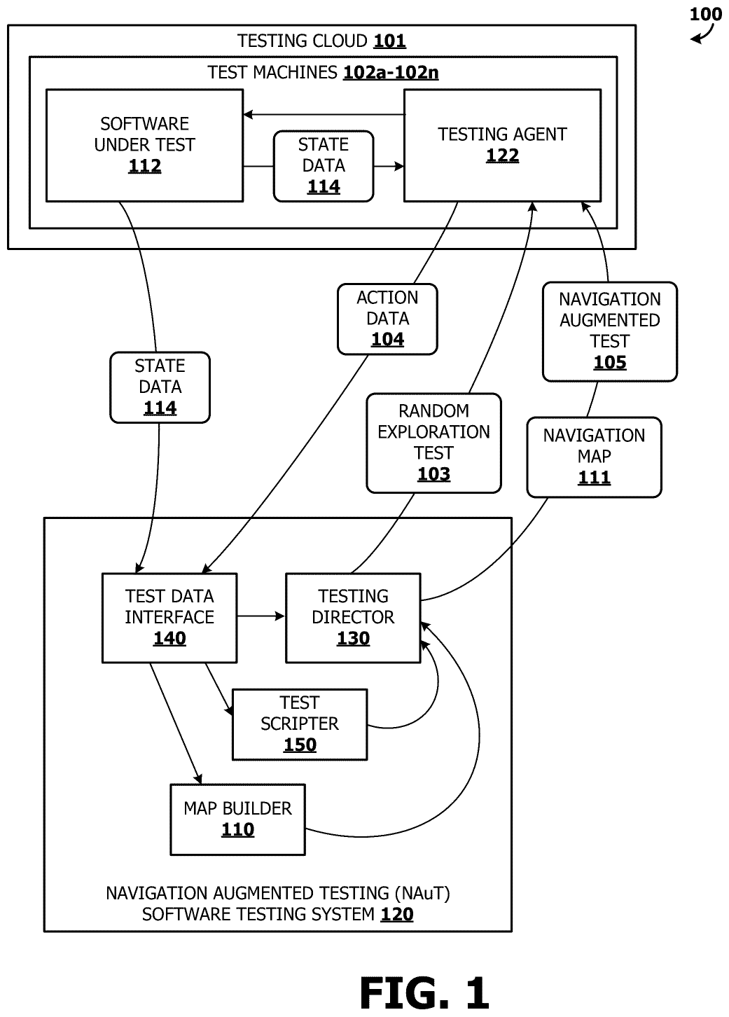

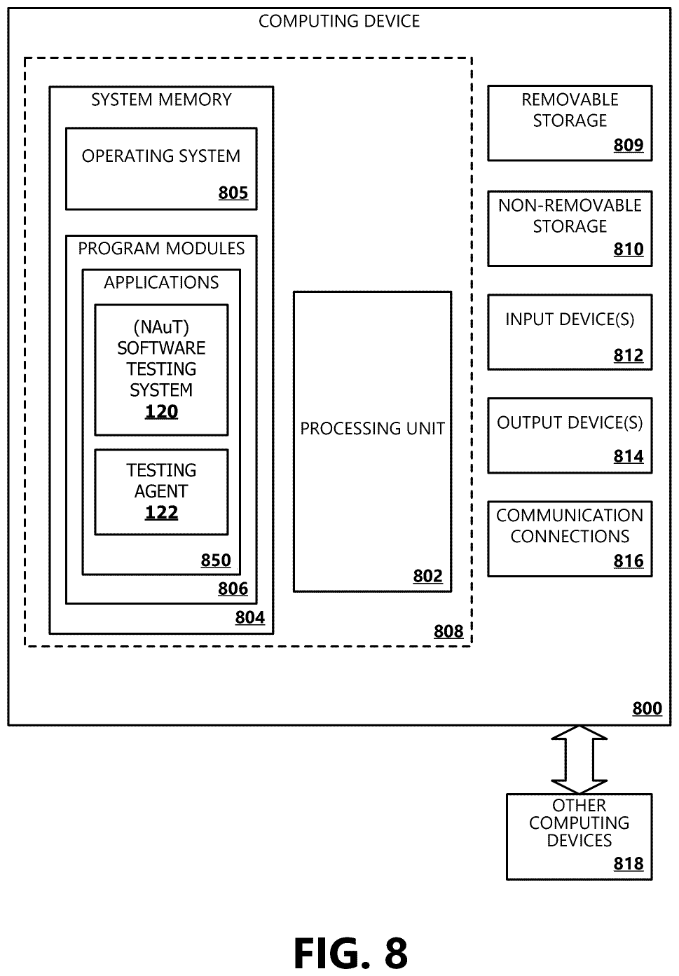

With reference now to FIG. 1, a block diagram of a software testing environment 100 is depicted in which NAuT in software product testing may be implemented in accordance with examples described herein. The example software testing environment 100, as depicted, is a combination of interdependent components that interact to form an integrated whole. Some components are illustrative of software applications, systems, or modules that operate on a computing device or across a plurality of computer devices. Any suitable computer device(s) may be used, including web servers, application servers, network appliances, dedicated computer hardware devices, virtual server devices, personal computers, a system-on-a-chip (SOC), or any combination of these and/or other computing devices known in the art. In one example, components of systems disclosed herein are implemented on a single processing device. The processing device provides an operating environment for software components to execute and utilize resources or facilities of such a system. An example of a processing device comprising such an operating environment is depicted in FIG. 8. In another example, the components of systems disclosed herein are distributed across multiple processing devices. For instance, input may be entered on a user device or client device and information may be processed on or accessed from other devices in the network, such as one or more remote cloud devices or web server devices. The network may include one or more local area networks (LANs) and/or wide area networks (WANs). In example implementations, a network includes the Internet, an intranet, and/or a cellular network, amongst any of a variety of possible public and/or private networks.

Among other components not shown, the software testing environment 100 includes a testing cloud 101 including one or more test machines 102a-102n (collectively, test machine 102) and a centralized NAuT software testing system 120 connected, in some examples, by a network. A testing cloud 101 refers to a cloud-based testing environment or platform that provides testing infrastructure, resources, and services for software testing and quality assurance activities. In other examples, the testing cloud 101 is a localized testing environment or platform. Any number of test machines 102 may be used in the testing cloud 101. Each test machine 102 includes a software product that is being tested (referred to herein as software under test 112) along with a simulated computing environment, including an operating system. In some examples, a test machine 102 is a virtual machine. In other examples, the test machine 102 is a physical machine. A testing agent 122 is an automated tool that is used to perform tests on software under test 112. For instance, the testing agent 122 is directed by a testing director 130 of the NAuT software testing system 120 to perform various interactions with software under test 112 and observe a resulting state. In some examples, the testing agent 122 operates on the test machine 102. In other examples, the testing agent 122 is located on a different machine than the software under test 112.

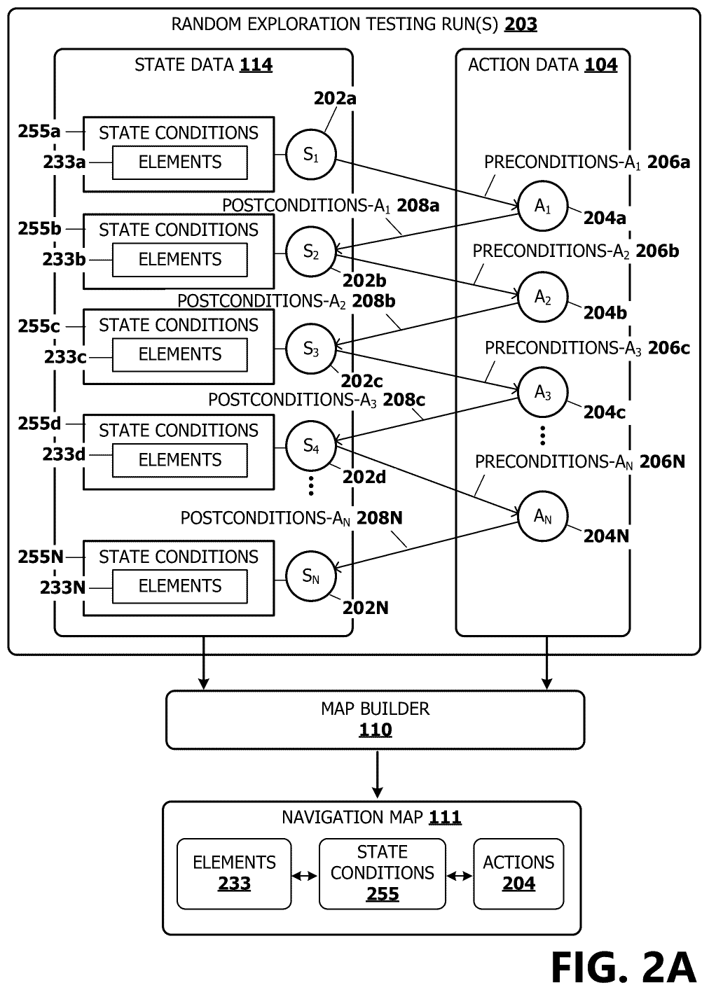

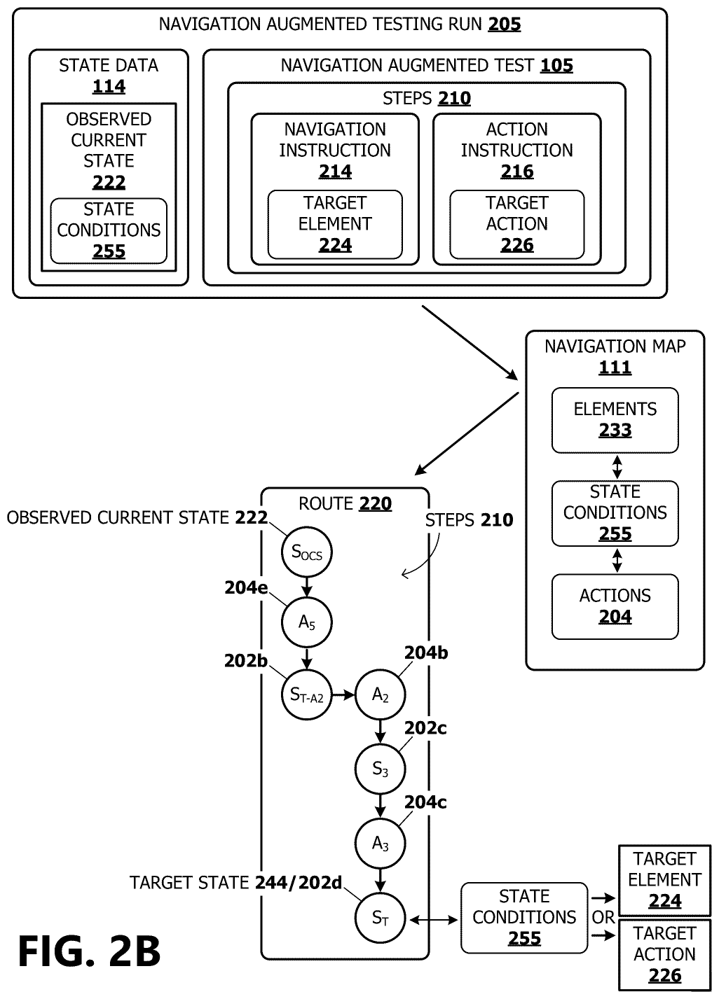

The testing director 130 assigns one or different test types to different test machines 102. For example, a first group of test machines 102a may be assigned to perform a random exploration test 103. With reference also to FIG. 2A, a diagram of example data collected from a random exploration testing run 203 is depicted. In some implementations, a random exploration testing run involves the testing agent 122 operating in a continuous loop of inspecting a state 202a-202N (collectively, state 202) of the software under test 112, taking an action 204a-204N (collectively, action 204) in association with an element 233a-233N (collectively, elements 233) identified in a first state 202a, and observing a next state 202b. The state 202 is a description of the software under test 112 and/or test machine 102 conditions at a point in time, such as identification of UI elements or other types of elements 233 that may be interacted with, a type of interaction each element 233 is able to receive, and/or other attributes about the elements 233. According to an example, the technology described herein starts with an undefined action space, where the action space is all actions 204 (e.g., select, hover, enter text, perform a function or operation) that the testing agent 122 and/or a user may take on elements 233 (e.g., buttons, menus or menu items, text boxes, checkboxes, dropdown lists, links, API functions, objects) of the software under test 112. The number of available actions 204 for each state 202 may be dynamic. In some examples, the software under test 112 may have 100,000 or more available actions 204. During use of the software under test 112, a user typically provides an input to interact with an element 233. During a random exploration testing run 203, the inputs are simulated by the testing agent 122. In an undefined action space, actions 204 available to the testing agent 122 outside of a current software state 202 (referred to herein as an observed current state) are unknown to the testing agent 122.

In some implementations, a set of conditions corresponding a state 202 (herein referred to as state conditions 255a-255N (collectively, state conditions 255)) is captured through one or more sensors (e.g., programmatically-defined sensors and/or an accessibility layer or function framework are used by applications, such as screen readers, for low vision users). In some examples, one or more sensors collect state data 114 observed in a first state 202a, including data about visible elements 233, such as UI elements 233 that are on screen of the test machine 102. In further examples, one or more sensors collect state data 114 about not-visible elements 233, such as Representational State Transfer (REST) API functions, objects, etc. According to an aspect, interacting with an element 233 produces a second state 202b with different state conditions 255 associated with various elements 233.

In some implementations, the testing agent 122 takes a first action 204a in association with a first element 233a observed/identified in the first state 202a. In some examples, the testing agent 122 randomly selects a first element 233a to interact with and, if multiple interaction types (e.g., left-click, right-click, hover) are possible, selects an interaction type. The selected interaction type is implemented on the first element 233a via an input (e.g., a keyboard stroke, mouse click, or touchscreen input, command, API call), which is reported to the NAuT software testing system 120 in action data 104. Interacting with the first element 233a corresponds to performing the first action 204a to change the first state 202a to a next state (e.g., a second state 202b). In examples, state conditions 255a in the first state 202a that allow the first element 233a to be interacted with are determined as preconditions 206a for performing the first action 204a on the first element 233a. Further, state conditions 255b in the second state 202b that changed (from the first state 202a) as a result of performing the first action 204a are determined as results/postconditions 208a of performing the first action 204a on the first element 233a. Based on state conditions 255b of the second state 202b, the testing agent 122 randomly selects a second element 233b to interact with and, if applicable, an interaction type. In examples, the state conditions 255b in the second state 202b that allow the second element 233b to be interacted with are determined as preconditions 206b for performing the second action 204b. The testing agent 122 performs the second action 204b by interacting with the second element 233b and then reports the associated action data 104 to the NAuT software testing system 120. Interacting with the second element changes state conditions 255 of the software under test 112 from the second state 202b to a next state (e.g., a third state 202c). Further, state conditions 255c in the third state 202c that changed (from the second state 202b) as a result of performing the second action 204b are postconditions 208b of performing the second action 204b. As additional actions 204c-204N are selected and performed, the corresponding action data 104 and state data 114 are collected by the NAuT software testing system 120. In examples, the NAuT software testing system 120 includes a test data interface 140 via which action data 104 is received from the testing agent 122 and state data 114 is received from the software under test 112 and/or the test machine 102.

As depicted in FIG. 1 and FIG. 2A, the NAuT software testing system 120 includes a map builder 110 that builds a model representing an action space of the software under test 112 (herein referred to as a navigation map 111). In some examples, the map builder 110 builds the navigation map 111 using the received action data 104 and state data 114 from one or more random exploration testing runs 203 on one or a plurality of test machines 102. In other examples, the map builder 110 build the navigation map 111 using information included in documentation about the software under test 112, such as a system design specification. For instance, natural language included in the system design specification may be translated into a mapping of at least a portion of the action space of the software under test 112. In some examples, the navigation map 111 includes a plurality of maps. The navigation map 111 includes a mapping of relationships elements 233 and state conditions 255 of different pre-and post-action states 202. Additionally, the navigation map 111 includes information about relationships between actions 204 performed on elements 233 and state conditions 255 of different pre-and post-action states 202. In some examples, the navigation map 111 includes a UI tree representing a structure of UI elements 233 in the UI of the software under test. In other examples, the navigation map 111 includes a bipartite graph. In yet other examples, another type of model is used to represent the relationships.

In examples, and with reference now to FIG. 2B, the testing director 130 directs the testing agent 122 to execute a navigation augmented test 105 in a navigation augmented testing run 205. In examples, the navigation augmented test 105 is a lightly-scripted automated test including steps for exercising a user scenario, where at least one step includes a navigation instruction 214 that instructs the testing agent 122 to “navigate to” a target element 224 rather than specifying each step that the testing agent 122 should take to cause the target element 224 to be available (e.g., displayed on screen and unobscured or otherwise available for interaction). The target element 224 is an element 233 or element associated with a specified action 204 specified in a step 210. For instance, the target element 224 provides the testing agent 122 with information about where to navigate and/or with what to interact.

In some implementations, the navigation augmented test 105 and/or the testing agent 122 includes one or more defined sensors that cause particular state conditions 255 about an observed current state 222 to be captured. The state conditions 255 may include a description of visible elements 233 and, in some examples, possible types of interaction with the elements 233, such as UI elements 233 that are on screen, non-visible elements 233, such as Representational State Transfer (REST) API functions, objects, etc. In examples, the testing agent 122 uses information about the observed current state 222 and the navigation map 111 to determine a route 220 including one or more steps 210 that, when performed by the testing agent 122, causes the testing agent 122 to interact with one or more elements 233 to cause state conditions 255 to change from an observed current state 222 to a target state 244. The target state 244 is when one or more state conditions 255 match one or more preconditions 206 (e.g., conditions that need to be true in order) for the target element 224 to be on screen and/or otherwise accessible for interaction. According to examples, one or more types of algorithms (e.g., a Stanford Research Institute Problem Solver (STRIPS), Markov decision processes (MDP), or other types of automated planning systems) and/or languages (e.g., Planning Domain Definition Language (PDDL) or Action Description Language (ADL)) are used to determine the route 220 using the navigation map 111. In some implementations, the testing agent 122 further executes the steps 210 included in the route 220 to navigate to the target state 244, where the target element 224 is available. In examples, the testing agent 122 is able to navigate to/produce the target state 244 without requiring the specific steps 210 to be authored.

In some implementations, the navigation instruction 214 further includes an action instruction 216, where the navigation instruction 214 specifies a target action 226 to perform on the target element 224. In other implementations, the action instruction 216 is included in a separate step 210. In some examples, the testing agent 122 determines whether state conditions 255 of the observed current state 222 satisfy preconditions 206 of a target state 244 for performing the target action 226 on the target element 224. When the preconditions 206 are not met, the testing agent 122 queries the navigation map 111 for a route 220 to the target state 244 from the observed current state 222. As an example, an action instruction 216 may include a target action 226 of renaming a document from a first name to a second name. Thus, an example target state 244 associated with the target action 226 may include preconditions 206 such as: the document existing and the UI of the software under test 112 including an element 233 associated with changing the document name can be interacted with (e.g., is available and accessible for interaction). In some examples, the testing agent 122 determines preconditions 206 of the target state 244 based on the action instruction 216 and then performs the steps 210 included in a determined route 220. Thus, when the preconditions 206 of the target action 226 are satisfied, the testing agent 122 further executes the target action 226 on the target element 224.

As depicted in FIG. 2B and according to one example, a navigation augmented test 105 may include a plurality of steps 210, where an example step 210 includes a navigation instruction 214 that instructs the testing agent 122 to “navigate to” a target element 224. For instance, a subsequent step 210 to the example step 210 may include an action instruction 216 (e.g., to perform a target action 226 in association with the target element 224 specified in the navigation instruction 214 or another target element 224). Using the navigation map 111, a route 220 is determined that allows the testing agent 122 to navigate from an observed current state 222 to a target state 244 where one or more preconditions 206 of the target action 226 are met.

In some examples, one or more state conditions 255 associated with the observed current state 222 meet preconditions 206 for performing a first step 210 included in the determined route 220. For instance, the first step includes performing an action (e.g., a fifth action 204e) in association with an element 233 included in the observed current state 222) to produce a second state 202b. In examples, one or more state conditions 255 associated with the second state 202b meet preconditions 206 for performing a second step 210 (e.g., performing a second action 204b in association with an element 233 observed in the second state 202b to produce a third state 202c). A final step 210 in the route 220 includes performing a third action 204c, where the third action 204c includes an interaction with an element 233 detected in the third state 202c. Results of performing the third action 204c are represented by post-action state conditions 255 (e.g., represented in a fourth state 202d). Because the third action 204c is included in the final step 210 of the route 220, the fourth state 202d represents a result of performing the navigation instruction 214 of the navigation augmented test 105.

In some examples, one or more state conditions 255 corresponding to the fourth state 202d represent a target state 244 associated with a target action 226 included in a step 210 subsequent to the navigation instruction 214. In other examples, the testing agent 122 uses the navigation map 111 to determine a next route 220 to a state 202 where preconditions 206 associated with performing the target action 226 are met, such as the target element 233 that is interacted with in association with performing the target action 226 is available for interaction (e.g., on screen or otherwise able to be interacted with) and in condition for the target action 226 to be performed.

In some examples, the navigation augmented test 105 further includes a validation step defining a desired result of performing a target action 226 (e.g., to validate a goal state has been achieved). In other examples, the target action 226 includes a validation step defining a desired result of performing a navigation instruction 214, such as:
1. Navigate to Settings->System->About
2. Validate that “Rename this PC” button is present and enabled.

In examples, validating that the navigation instruction 214 and/or target action 226 was performed as expected may include determining whether state data 114 describing the observed current state 222 of the software under test 112 after performing the navigation instruction 214 and/or target action 226 reflects achieving the desired result the software under test 112 is expected to exhibit. In some examples, the goal state is defined by one or more state conditions 255 (e.g., “Rename this PC” button is present and enabled) defined as reward criteria and assigned a reward value when produced by the testing agent 122. For instance, the reward value indicates the level of success or accomplishment of the target action 226 performing as expected, where the reward value may be a numerical score, a binary value (success/failure), or another form of evaluation metric.

In some implementations, the navigation augmented test 105 is authored by a user. In other implementations, the navigation augmented test 105 is authored by an automated test scripter 150. In further implementations, the navigation augmented test 105 is authored based on input by a user and the automated test scripter 150. According to an example, the automated test scripter 150 authors scripts for navigation augmented tests 105 by recording actions 204 performed by a user and generating test instructions (e.g., navigation instructions 214 and action instructions 216) as the user performs the steps of the navigation augmented tests 105. In some implementations, the automated test scripter 150 is in communication with the navigation map 111. The automated test scripter 150 may use the navigation map 111 to determine other routes 220 to target elements 224 and/or other target actions 226. In some examples, the automated test scripter 150 suggests the other route 220 as a recommended set of steps 210 to include in the navigation augmented test 105. In other examples, the automated test scripter 150 automatically updates the navigation augmented test 105 when the other route 220 is determined.

In examples, navigation augmented tests 105 can invoke targets (e.g., target elements 224 and target actions 226) throughout the UI (or other interfaces) without a test author or test scripter 150 needing to specify all the steps 210 to navigate to the element 233. For example, the test author would only need to specify a target element 224, while the navigation map 111 is used to handle navigating to the correct state 202. If the UI surrounding the target element 224 changes after the navigation augmented test 105 has been authored (e.g., if the target element 224 is moved to a different menu and changes how a user navigates to the target element 224), the navigation augmented test 105 can self-update based on new navigation data (e.g., steps 210 of a new route 220) to a state 202 in the navigation map 111 where the target element 224 is available and accessible for interaction. That is, no maintenance work is required to be performed by a user (e.g., a test owner) for the navigation augmented test 105 to successfully exercise a modified scenario.

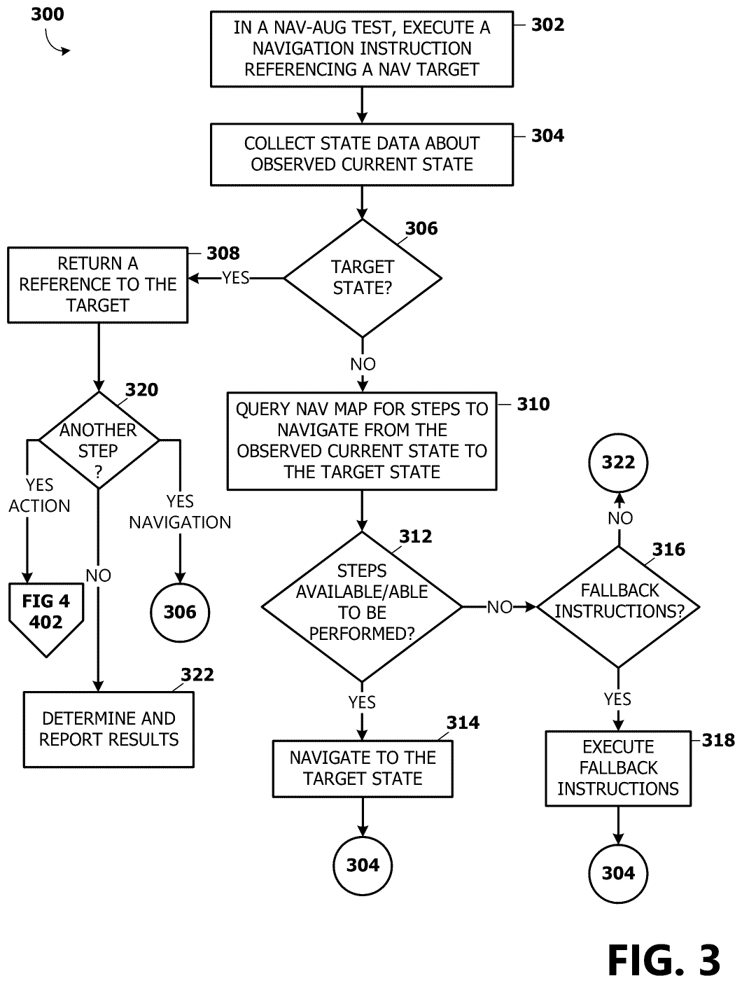

FIG. 3 depicts a flow diagram of a first example method 300 of executing a navigation augmented test 105 of various possible methods of execution. The navigation augmented test 105 is received by the testing agent 122, which is scripted to be executed on software under test 112. At operation 302, a navigation instruction 214 included in the navigation augmented test 105 is executed. In examples, the navigation instruction 214 specifies to navigate to a target element 224. An example navigation instruction 214 may be “Navigate to ‘Personalization>Colors’ in Settings”, where ‘Personalization>Colors’ is the target element 224.

The method 300 proceeds to operation 304, where in executing the navigation instruction, state data 114 describing a current state of the software under test 112 and/or the test machine 102 on which the software under test 112 is running is collected. In examples, the state data 114 is captured by one or more sensors that are defined to capture particular conditions of an observed current state 222. In some examples, the state data 114 includes a description of all UI elements that are on screen, API elements that are available, and/or other conditions.

At decision operation 306, preconditions 206 corresponding to causing the target element 224 to be available/interactable (e.g., conditions of the target state 244 associated with the target element 224) are determined. In some examples, a precondition 206 associated with navigating to a target element 224 is that the target element 224 is available for interaction. At decision operation 306, conditions captured in association with the observed current state 222 are compared against the preconditions 206 associated with a state 202 where the target element 224 is available for interaction. A determination is made as to whether the preconditions 206 are satisfied and, thus, whether the observed current state 222 is the target state 244 where the target element 224 is available (e.g., on screen in the case of a UI element). In some examples, if the target element 224 is available, another determination is made as to whether the target element 224 is in a state that allows interaction (e.g., a UI element is not hidden or obstructed). In further examples, a determination is made as to whether the state conditions 255 of the observed current state 222 meet preconditions 206 associated with a subsequent target action 226, such as a condition of the target element 224 being in a state that allows the subsequent target action 226 to be performed. When conditions of the target state 244 are satisfied, the testing agent 122 records a reference (e.g., a unique identifier assigned) to the target element 224 at operation 308.

If, at decision operation 306, state conditions 255 of the target state 244 are not satisfied (e.g., conditions of the observed current state 222 do not match the target state 244 to make the target element 224 available), the method 300 proceeds to operation 310 where the testing agent 122 queries the navigation map 111 to determine one or more steps 210 (e.g., interactions) to perform to produce the target state 244 from the observed current state 222.

In some implementations, a determination is made at decision operation 312 as to whether a route 220 can be determined including one or more steps 210 (e.g., actions 204) that can be performed to produce the target state 244 associated with the target element 224 from the observed current state 222. When a route 220 is available/determined, the method 300 proceeds to operation 314, where the steps 210 are performed to navigate to the target state 244. In some examples, the method 300 then returns to operation 304 to collect state data 114 about an observed current state 222 after performing the steps 210 (e.g., or after performing each step 210) and further proceeds again to decision operation 306 to determine whether the observed current state 222 matches the target state 244 (e.g., or a target state 244 associated with each step 210). For instance, a step 210 may be unable to be performed due to a change made to the software under test 112, a route 220 to a target state 244 from a previous state 202 being not yet known, or another issue. In some examples, when a step 210 cannot be performed, the navigation map 111 is queried for another route 220 at operation 310.

In some implementations, when a route 220 cannot be determined and/or navigated to produce the target state 244, the method 300 proceeds to decision operation 316 to determine whether the navigation augmented test 105 includes fallback instructions (e.g., explicit instructions to navigate to the target element 224). Fallback instructions may cause the testing agent 122 to perform an alternate set of scripted steps. This may be helpful in scenarios where a test author desires to interact with a target element 224 that was not present in a previous random exploration test run 203. When fallback instructions are provided, the testing agent 122 is able to navigate to the target element 224 with the explicit instructions at operation 318. For instance, this may be performed when exercising the navigation augmented test 105 until the navigation map 111 has obtained sufficient historical data (e.g., state data 114 and action data 104 in testing runs) for determining the steps 210 to navigate to the target element 224. In some examples, the method 300 returns to operation 304 to collect state data 114 about an observed current state 222 after executing the fallback instructions.

In some examples, when state conditions 255 for producing the target state 244 are satisfied (at decision operation 306) and a reference to the target element 224 is recorded at operation 308, the method 300 proceeds to decision operation 320, where a determination is made as to whether the navigation augmented test 105 includes a next instruction (e.g., another navigation instruction 214, an action instruction 216, or navigation instruction 214 including an action instruction 216). When another instruction is not included in the navigation augmented test 105, a result of performing the steps of the navigation augmented test 105 is determined and reported at operation 322. In some examples, a determination is made the result indicates that the navigation augmented test 105 passed and a tested scenario behaved as expected. In other examples, a determination is made the result indicates that the navigation augmented test 105 failed, such as when the testing agent 122 is unable to perform steps to produce one or more target states 244. In yet other examples, a determination is made the result indicates that the navigation augmented test 105 succeeded with warnings, such as when the testing agent 122 executes fallback instructions or when operating in a mode where a warning is reported when a more efficient route 220 (e.g., fewer steps 210) than a set of scripted steps 210 is determined.

In some examples, when a subsequent navigation instruction 214 is determined at decision operation 320, the method 300 returns to operation 306, where a determination is made as to whether a set of state conditions 255 of the observed current state 222 match preconditions 206 of a state 202 where a specified target element 224 is available for interaction. When preconditions of the target state 244 are not satisfied, the testing agent 122 may repeat operations 310-318 to determine a route 220 to the specified target element 224.

In some implementations, the navigation augmented test 105 further includes an action instruction 216 specifying a target action 226 to perform on a target element 224. In some examples, the target element 224 in the action instruction 216 is the target element 224 specified in the preceding navigation instruction 214. In other examples, the target element 224 in the action instruction 216 is a different element. When an action instruction 216 is determined at decision operation 320 (e.g., or a target action 226 is identified in a combined action instruction 216 and navigation instruction 214), the method 300 proceeds to operation 402 of method 400.

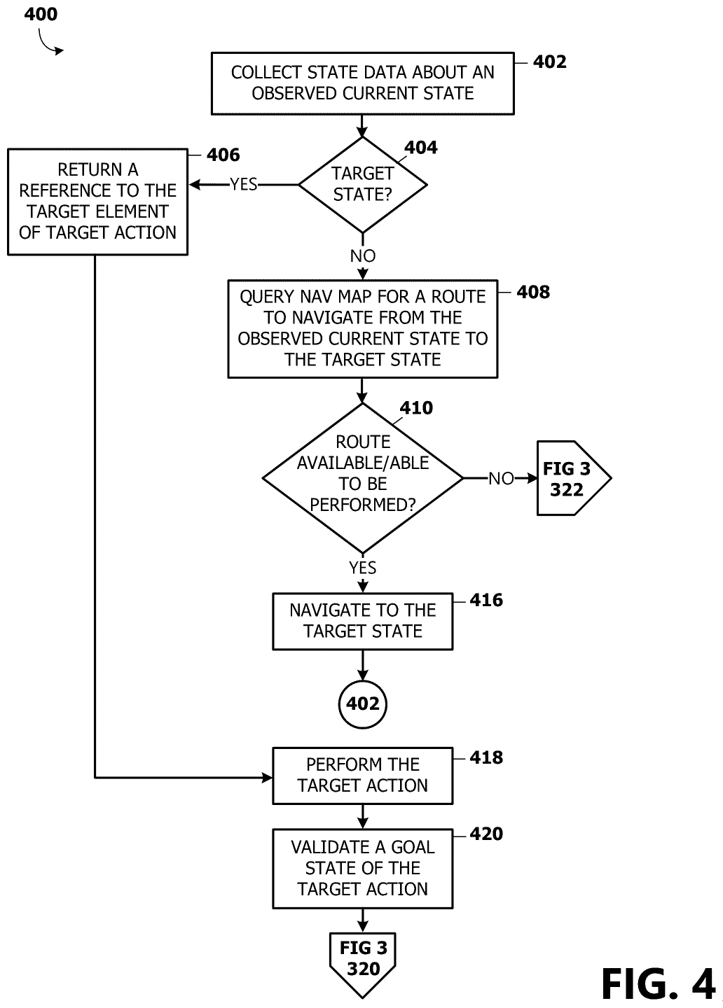

With reference now to FIG. 4, a flow diagram of a second example method 400 of executing the navigation augmented test 105 is depicted. For instance, the second example method 400 includes executing an action instruction 216 of the navigation augmented test 105, where the action instruction 216 specifies a target action 226 to perform in association with a target element 224. At operation 402, state data 114 describing a current state of the software under test 112 and/or the test machine 102 on which the software under test 112 is running is collected and compared to a target state 244 associated with the target action 226. In some examples, the state data 114 describes state conditions 255 captured by one or more defined sensors. For instance, the one or more sensors are defined to capture particular conditions of an observed current state 202 based on a set of preconditions 106 for performing the target action 226. As an example, the target action 226 may be “Click on ‘Show accent color on title bars and window borders,’” where a ‘Show accent color on title bars and window borders’ UI element 233 is interacted with in (e.g., clicked on) in the target action 226. For instance, the collected state data 114 includes a description of state conditions 255, such as details about UI elements 233 that are on screen, where an example target state 244 associated with the target action 226 has a precondition 206 that the ‘Show accent color on title bars and window borders’ UI element is on screen and is available to be interacted with (e.g., is not obscured). Another example target action 226 is “Delete 10 files at once that are all larger than 1 GB,” where an example target state 244 associated with the target action 226 has a precondition 206 that a file folder including at least ten files larger than 1 GB exists. The collected state data 114 may include a description of attributes of files in one or more file folders.

At decision operation 404, a determination is made as to whether state conditions 255 of the observed current state 222 satisfy preconditions 206 of the target state 244 associated with the target action 226. When the preconditions 206 are satisfied, a reference to the target element 224 of the target action 226 is recorded at operation 406. Alternatively, when the preconditions 206 are not satisfied and the observed current state 222 is not the target state 244 for performing the target action 226, the method 400 proceeds to operation 408, where the testing agent 122 queries the navigation map 111 to determine a route 220 including one or more steps 210 (e.g., actions 204) to perform from the observed current state 222 to produce a state 202 where state conditions 255 satisfy preconditions 206 to perform the target action 226. In other implementations, rather than querying the navigation map 111 to perform the target action 226, the navigation augmented test 105 is configured to treat the failure/inability to perform the target action 226 (e.g., when the observed current state 222 is not the target state 244 for performing the target action 226) as fatal and proceed to operation 322 in FIG. 3 to determine and report the failure. For instance, in some implementations, the navigation map 111 is used when performing navigation instructions 214, and not when performing action instructions 216.

In some implementations, a determination is made at decision operation 410 as to whether steps 210 can be determined from information in the navigation map 111 to build a route 220 to produce the target state 244 for performing the target action 226. In some examples, when a determination is made that a route 220 cannot be determined or navigated to produce the target state 244, the method 400 continues to operation 322 in FIG. 3 to determine and report a failure. In other examples, the navigation augmented test 105 includes fallback instructions (e.g., explicit instructions to produce the target state 244 from the observed current state 222). When fallback instructions are provided, the testing agent 122 is able to navigate to the target state 244 with the fallback instructions.

When a route 220 is available/determined at decision operation 410, the method 400 proceeds to operation 416, where the steps 210 of the route 220 are performed to navigate to the target state 244. In some examples, the method 400 then returns to operation 402 to collect state data 114 about an observed current state 222 after navigating to the target state 244 (e.g., after performing the steps 210 or after performing each step 210 in the route 220). Continuing to decision operation 404, a determination is made as to whether state conditions 255 of the observed current state 222 satisfy preconditions 206 of the target state 244 (e.g., or each target state 244 of each step 210 in the route 220). In some examples, when a step 210 in the route 220 cannot be performed, the navigation map 111 is queried for another route 220 at operation 408.

In examples, a determination is made at decision operation 404 when the preconditions 206 of the target state 244 are met, and a reference to the target element 224 of the target action 226 is recorded at operation 406. The method 400 then proceeds to operation 418, where the target action 226 is performed. For instance, the testing agent 122 may click on the ‘Show accent color on title bars and window borders’ UI element 202, delete ten files at once that are all larger than 1 GB, empty a shopping cart, or perform another example target action 226 corresponding to testing a scenario of the software under test 112.

In some examples, at operation 420, the target action 226 is validated. For instance, the navigation augmented test 105 may include a validation instruction defining a desired result of performing the target action 226 (e.g., to validate a goal state has been achieved). In examples, validating that the target action 226 was performed as expected may include determining whether state data 114 describing the observed current state 222 of the software under test 112 after performing the target action 226 reflects achieving a desired result (e.g., that the title bar color has changed, the files were deleted, or the items were removed from the shopping cart). In some examples, the goal state is defined by reward criteria and assigned a reward value when produced by the testing agent 122.

In some examples, the method 400 returns to operation 320 of method 300, where the testing agent 122 determines whether the navigation augmented test 105 includes another instruction/step 210 to execute. In some examples, when no further instructions/steps are included, results of the navigation augmented testing run 205 are reported at operation 322.

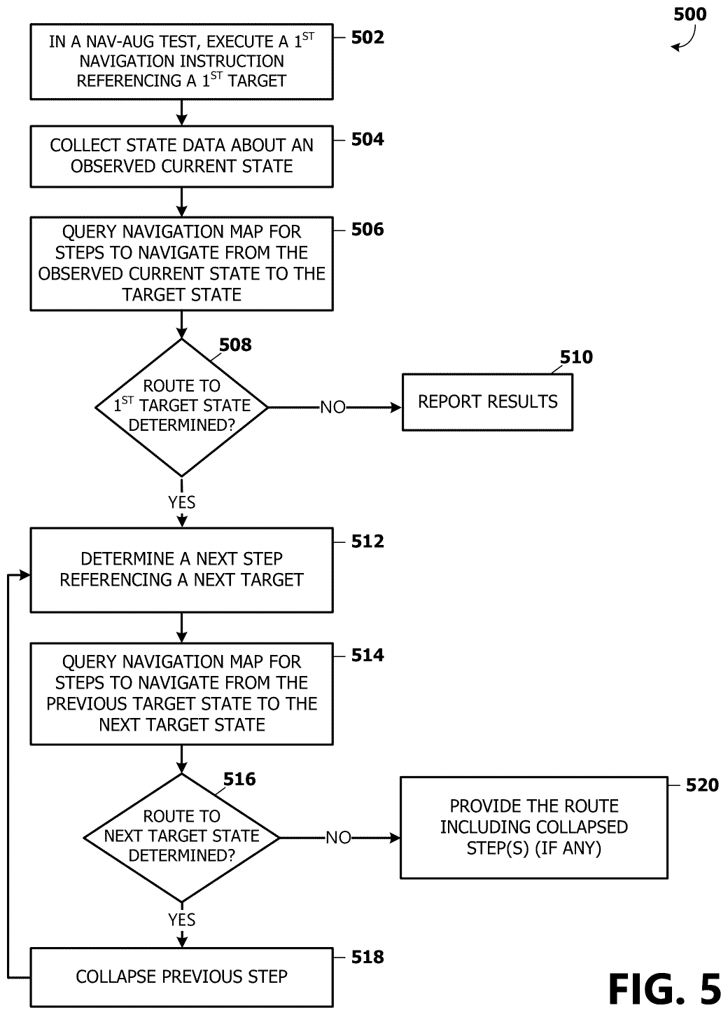

With reference now to FIG. 5, a flow diagram of a third example method 500 of executing a navigation augmented test 105 is depicted, where the third example method 500 includes performing a look-ahead technique. In some examples, the method 500 is performed to simplify the navigation augmented test 105. In further examples, performing method 500 improves resiliency of the navigation augmented test 105 to product changes. The navigation augmented test 105 is received by the testing agent 122 to execute on software under test 112 and, at operation 502, a first navigation instruction 214a included in the navigation augmented test 105 is executed. The first navigation instruction 214a specifies to navigate to a first target element 224a (e.g., “Navigate to ‘A,’” where an ‘A’ element 202 is the first target element 224a).

The method 500 proceeds to operation 504, where, in executing the navigation instruction, state data 114 describing an observed current state 222 of the software under test 112 and/or the test machine 102 on which the software under test 112 is running is collected. In examples, the state data 114 is captured by one or more sensors that are defined to capture particular state conditions 255 of the observed current state 222. In some examples, the state data 114 includes a description of all UI elements that are on screen. In other examples, the state data 114 includes a description of other state conditions 255.

At operation 506, a navigation map 111 built for the software under test 112 based on historical data from one or more previous random exploration testing runs 203 is queried for preconditions 206 corresponding to a first target state 244a, where, when the preconditions 206 of the first target state 244a are met, the first target element 224a (e.g., the ‘A’ element) is available/interactable. In examples, the navigation map 111 is further queried for a route 220 including one or more steps 210 to navigate to the first target state 244a from the observed current state 222.

At decision operation 508, a determination is made as to whether the route 220 is determined. When steps 210 to build the route 220 cannot be determined, the method 500 proceeds to operation 510, where a result of failure to navigate to the first target state 244a is reported. In other implementations, if fallback instructions are provided, explicit instructions included in the fallback instructions are performed to navigate to the first target state 244a from the observed current state 222. The method 500 may then be repeated for a next navigation instruction 214 in the navigation augmented test 105.

When the route 220 is determined, the method 500 proceeds to operation 512, where the testing agent 122 is instructed to “look ahead” to a next step 210 in the navigation augmented test 105. In some examples, the next step 210 includes a navigation instruction (e.g., a second navigation instruction 214b). For instance, the second navigation instruction 214b may specify to navigate to a second target element 224b (e.g., “Navigate to ‘B,’” where a ‘B’ element is the second target element 224b). In other examples, the next step 210 includes an action instruction 216. For instance, the action instruction 216 may specify to perform a target action 226 in association with a target element 224 (e.g., the second target element 224b or another element 233).

At operation 514, the navigation map 111 is queried for preconditions 206 corresponding to a second target state 244b where, in the second target state 244b, the second target element 224b (e.g., the ‘B’ element) is available/interactable. In some examples, such as when the next step 210 includes an action instruction 216, the preconditions 206 correspond to a state 202 where state conditions 255 are met to perform the target action 226. At operation 514, the navigation map 111 is further queried for a route 220 including one or more steps 210 to navigate to the second target state 244b from the first target state 244a.

At decision operation 516, a determination is made as to whether the route 220 is determined. When the route 220 is determined, the method 500 proceeds to operation 518 where the previous navigation instruction (e.g., the first navigation instruction 214a) is tagged as redundant or not needed. In some examples, when a step 210 includes an instruction that is tagged as redundant or not needed, the step 210 is collapsed (e.g., ignored or combined with at least one other step 210 into a single step 210). As an example, the determined route 220 to the second target state 244b from the observed current state 222 is known and, thus, the first navigation instruction 214a is not necessary to navigate to the second target state 244b. Collapsing steps 210 that may be redundant can simplify the navigation augmented test 105, thus causing the navigation augmented test 105 to be more efficient to process and easier to manage.

In examples, the method 500 returns to operation 512, where the testing agent 122 is instructed to “look ahead” to a next step 210 in the navigation augmented test 105. In some examples, the next step 210 includes a navigation instruction (e.g., a third navigation instruction 214c) specifying to navigate to a third target element 224c (e.g., “Navigate to ‘C,’” where a ‘C’ element is the third target element 224c). In other examples, the next step 210 includes an action instruction 216 to perform another target action 226.

At operation 514, the navigation map 111 is queried for preconditions 206 corresponding to a third target state 244c, where, in the third target state 244c, the third target element 224c (e.g., the ‘C’ element) is available/interactable. In some examples, such as when the next step 210 includes an action instruction 216, the preconditions 206 correspond to a state 202 where state conditions 255 are met to perform the other target action 226. At operation 514, the navigation map 111 is further queried for a route 220 including one or more steps 210 to navigate to the second target state 244b from the first target state 244a.

At decision operation 516, a determination is made as to whether the route 220 is determined. When the route 220 is determined, the method 500 proceeds to operation 518 where the previous navigation instruction (e.g., the first navigation instruction 214a) is tagged as redundant or not needed. For instance, steps 210 to produce the third target state 244c from the observed current state 222 are known and, thus, neither the first step 210 nor the second step 210 are necessary to navigate to the third target state 244c. In some examples, the second step 210 including the second navigation instruction 214b is also collapsed.

If at decision operation 516, a determination is made that a route 220 to the target state 244 cannot be determined, the method 500 proceeds to operation 520, where the route 220 including one or more collapsed navigation instructions 214 is provided. In some examples, the simplified route 220 is provided to a user (e.g., suggested as a recommended set of steps 210 to include in the navigation augmented test 105). In other examples, the simplified route 220 is provided to the automated test scripter 150, which automatically updates the navigation augmented test 105 with the simplified route 220. In yet other examples, at operation 520, the route 220 is provided with one or more steps 210 tagged as redundant (e.g., the steps 210 are not collapsed). In yet further examples, the simplified route 220 is executed by the testing agent 122 (e.g., using operations included in FIGS. 3 and/or 4) prior to being provided to the user and/or prior to updating the navigation augmented test 105. For instance, the simplified route 220 is validated before being provided to the user or being used to update the navigation augmented test 105. In some examples, the method 500 is repeated until a validation instruction is encountered rather than a next navigation instruction 214 at operation 512.

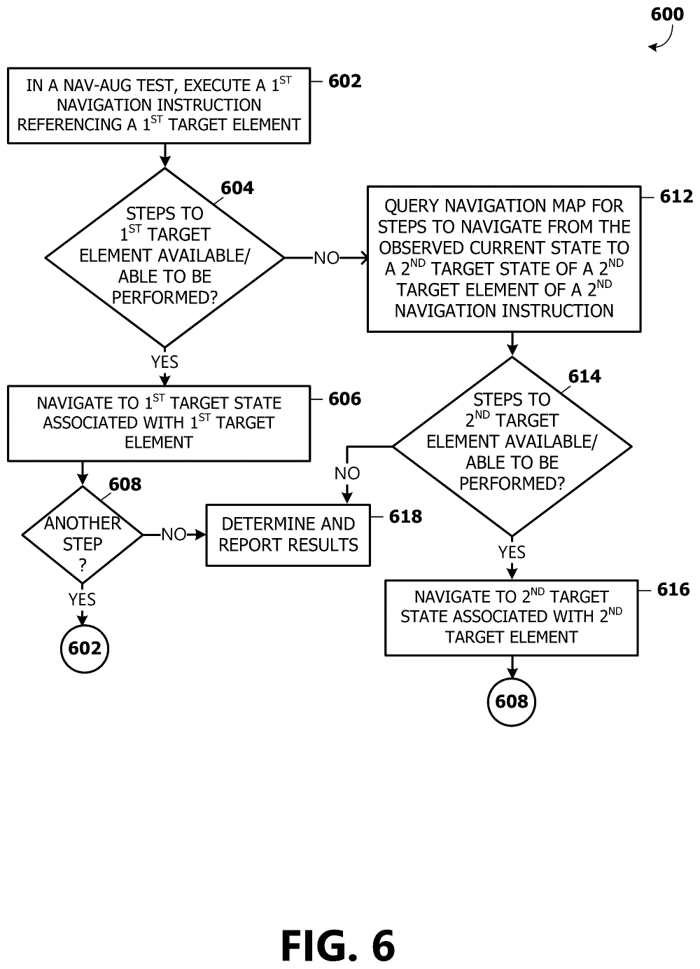

With reference now to FIG. 6, a flow diagram of a fourth example method 600 of executing a navigation augmented test 105 is depicted, where the fourth example method 600 includes performing a look-ahead technique. In some examples, performing the method 600 improves resiliency of the navigation augmented test 105 to product changes. The fourth example method 600 differs from the third example method 500 in that the testing agent 122 performs the look-ahead technique when a navigation instruction 214 provided by a test author (e.g., a user or an automated test scripter 150) cannot be performed, such as because the software under test 112 has changed (e.g., a target element 224 associated with a navigation instruction 214 no longer exists, has moved, has been renamed, is hidden, or is otherwise not available). For instance, the following example steps 210 of a navigation augmented test 105 may have been authored before a route 220 to produce a third target state 244c (e.g., to the “Colors” settings in a “Settings” application) from an observed current state 222 may have been learned:
1. Navigate to Settings
2. Navigate to Personalization
3. Navigate to Colors
4. Click on “Show accent color on title bars and windows borders”
5. Validate that title bar color has changed.

Consider, as an example, the navigation instruction 214 corresponding to navigating to the Settings application has been performed and, at operation 602, a first navigation instruction 214a (e.g., “Navigate to Personalization”) is then executed. The first navigation instruction 214a specifies to navigate to a first target element 224a (e.g., a Personalization UI element). In examples, the testing agent 122 attempts to navigate to a first target state 244a where the first target element 224a is available/in a state for interaction. For instance, the testing agent 122 may perform operations of method 300 to collect state data 114 about an observed current state 222, determine preconditions 206 of the first target state 244a, and when the observed current state 222 does not satisfy the preconditions 206 of the first target state 244a, use the navigation map 111 to determine a route 220 of one or more steps 210 to perform to navigate from the observed current state 222 to the first target state 244a.

At decision operation 604, a determination is made as to whether the route 220 is available and/or can be performed. In some examples, a route 220 is determined and the one or more steps 210 are able to be performed to navigate to the first target state 244a from the observed current state at operation 606. In other examples, if the first target element 224a (e.g., the Personalization UI element) was renamed to “Customization”, the navigation augmented test 105 may, using other methods, fail. However, method 600 proceeds to operation 612 where the testing agent 122 “looks ahead” to a next step 210 (e.g., including a second navigation instruction 214b or an action instruction 216) and then uses the navigation map 111 to determine preconditions 206 of a second target state 244b of a second target element 224b associated with the next step 210.

In some examples, a route 220 of one or more steps 210 to navigate to the second target state 244b from the observed current state 222 is determined using the navigation map 111 at decision operation 614. The method 600 proceeds to operation 616, where the one or more steps 210 are performed to navigate to the second target state 244b. For instance, the testing agent 122 is able to learn how to navigate to the second target state 244b from the observed current state 222 from data collected from other test runs.

After performing operation 616 or operation 606, the method 600 continues to decision operation 608, where a determination is made as to whether the navigation augmented test 105 includes a subsequent step 210 to execute. In some examples, when no further navigation instructions 214 or action instructions 216 are included (e.g., a validation instruction is executed), results of the navigation augmented testing run 205 are reported at operation 618. When the navigation augmented test 105 includes a next navigation instruction 214 or action instruction 216, the method 600 may restart at operation 602, where another first navigation instruction 214a specifying another first target element to navigate to is executed. At operation 618, a result of performing the one or more steps 210 of the determined route 220 to navigate to the second target state 244b is determined and reported. In some implementations, when exercising a navigation augmented test 105 where a route 220 is built to navigate around a step 210 that cannot be performed, a result of the navigation augmented testing run 205 may be determined and reported as “succeeded with warnings” or otherwise relying on the look-ahead technique for improving resiliency of the navigation augmented test 105.

In some implementations, incorrect (and thus unnecessary) steps 210 (e.g., the first navigation instruction 214a specifying to navigate to “Personalization” when “Personalization” was renamed to “Customization”) are automatically removed from the navigation augmented test 105. In further implementations, an incorrect navigation instruction 214 is automatically replaced with a navigation instruction 214 to a valid target element 224 (e.g., the “Customization” UI element). When a route 220 of one or more steps 210 to navigate to the second target state 244b cannot be built at decision operation 614, the method 600 may proceed to operation 618, where a result of failing to complete the first and second navigation instructions 214 is reported.

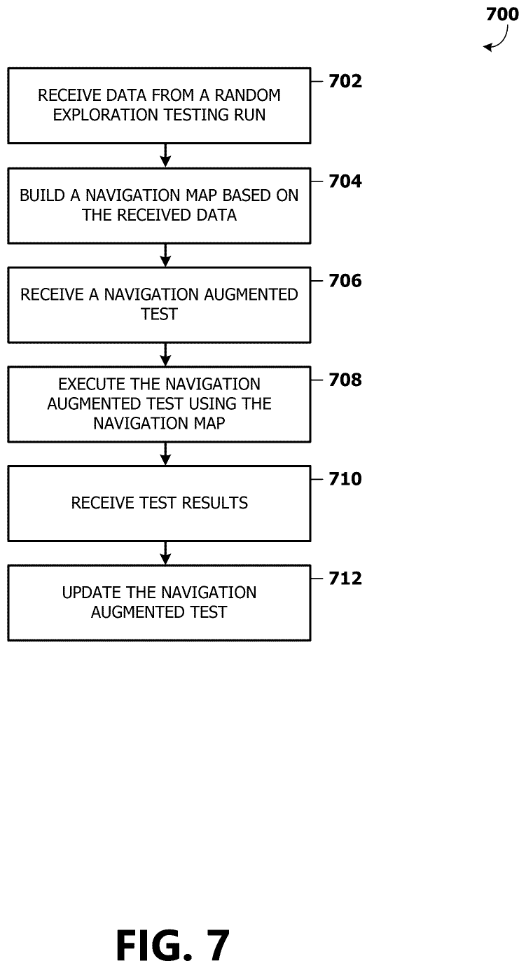

With reference now to FIG. 7, a flow diagram is depicted of an example method 700 of performing navigation augmented testing according to an aspect. At operation 702, data collected from performing one or more random exploration testing runs 203 is received. In some examples, the collected data includes state data 114 describing conditions of the software under test 112 and/or test machine 102 at a point in time (e.g., a state 202). Example state conditions 255 include UI elements or other types of elements 233 that may be interacted with, a type of interaction each element 233 is able to receive, and/or other attributes about the elements 233.

At operation 704, a navigation map 111 is built based on the received data. In examples, the navigation map 111 includes information about relationships between elements 233 and/or actions 204 performed on the elements 233 and different pre-and post-action states 202, which can be used to determine pre-and postconditions corresponding to making a target element 224 available and/or in a state for different interactions to be performed.

At operation 706, a navigation augmented test 105 is authored and received. In examples, the navigation augmented test 105 is a lightly scripted test where one or more steps 210 of the test may be condensed into a navigation instruction 214 to navigate to a specified target element 224. In some examples, the navigation instruction 214 further includes an action instruction 216 to perform a target action 226 in association with the specified target element 224. In other examples, the action instruction 216 is included in a step 210 subsequent to the navigation instruction 214.

At operation 708, the navigation augmented test 105 is executed by a testing agent 122 on the software under test 112. For instance, testing director 130 assigns the navigation augmented test 105 to the testing agent 122, where the testing agent 122 executes steps 210 included in the navigation augmented test 105 to test at least one user scenario. In examples, the testing agent 122 performs one or a combination of methods 300, 400, 500, and 600 to perform the navigation augmented test 105. For instance, when the testing agent 122 executes a step 210 including a navigation instruction 214 to navigate to a specified target element 224, the testing agent 122 uses the navigation map 111 to determine a route 220 including one or more steps 210 for the testing agent 122 to execute to produce a state 202 of the software under test 112 where the specified target element 224 is available and/or otherwise accessible for the interaction. When the testing agent 122 executes a step 210 including an action instruction 216 to perform a target action 226, the testing agent 122 uses the navigation map 111 to determine a route 220 including one or more steps 210 for the testing agent 122 to execute to produce a state 202 of the software under test 112 where the target element 224 specified in the navigation instruction 214 or another target element 224 is available for the target action 226 to be performed.

At operation 710, results from the navigation augmented testing run 205 are received. In some examples, the results indicate when a navigation instruction 214 and/or an action instruction 216 (or another step 210) are performed successfully. In other examples, the results indicate when an action instruction 216 (or another step 210) fail. In further examples, the results indicate when a simplified route 220 is determined that allows one or more steps 210 in the navigation augmented test 105 to be collapsed. In yet further examples, the results indicate when a step 210 in the navigation augmented test 105 “succeeded” but “with warnings,” such as when the step 210 is identified as incorrect and/or extraneous, but where a new route 220 is discovered to produce a target state 244 not achieved by the incorrect and/or extraneous step 210. Other reported information is received in other examples.

In some examples, operation 712 is performed to update the navigation augmented test 105. For instance, the NAuT software testing system 120 may update the navigation augmented test 105 based on a route 220 discovered during testing. In some examples, one or more existing steps 210 are collapsed, replaced, and/or otherwise modified based on the discovered route 220.

FIG. 8 and the associated description provide a discussion of a variety of operating environments in which examples of the invention may be practiced. However, the devices and systems illustrated and discussed with respect to FIG. 8 is for purposes of example and illustration and is not limiting of a vast number of computing device configurations that may be utilized for practicing aspects of the invention, described herein. FIG. 8 is a block diagram illustrating physical components (i.e., hardware) of a computing device 800 with which examples of the present disclosure may be practiced. In a basic configuration, the computing device 800 may include at least one processing unit and a system memory 804. in examples, the processing unit(s) (e.g., processors) are referred to as a processing system 802. Depending on the configuration and type of computing device, the system memory 804 may comprise volatile storage (e.g., random access memory), non-volatile storage (e.g., read-only memory), flash memory, or any combination of such memories. The system memory 804 may include an operating system 805 and one or more program modules 806 suitable for running software applications 850 (e.g., the NAuT software testing system 120 and/or the testing agent 122).

The operating system 805, for example, may be suitable for controlling the operation of the computing device 800. Furthermore, aspects of the invention may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the processing system 802, the program modules 806 may perform processes including one or more of the operations of the methods illustrated in FIGS. 3-7. Other program modules that may be used in accordance with examples of the present invention and may include applications such as electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 800 on the single integrated circuit (chip). Examples of the present disclosure may also be practiced using other technologies capable of performing logical operations such as, for example, AND, OR, and NOT, including mechanical, optical, fluidic, and quantum technologies.

The computing device 800 may also have one or more input device(s) 812 such as a keyboard, a mouse, a pen, a sound input device, a touch input device, etc. The output device(s) 814 such as a display, speakers, a printer, etc. may also be included. The aforementioned devices are examples and others may be used. The computing device 800 may include one or more communication connections 816 allowing communications with other computing devices 818. Examples of suitable communication connections 816 include RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, radio frequency (RF), infrared, and other wireless media.

According to an aspect, a method is provided for performing a navigation augmented test for a software under test, comprising: receiving a navigation map of the software under test; performing a first step of a primary set of steps included in the navigation augmented test, wherein the first step specifies a first interaction with a first target element; determining a first set of preconditions associated with a first target state of the software under test where the first interaction is available to be performed with the first target element; determining a first set of state conditions associated with a first observed current state of the software under test; in response to determining the first set of state conditions does not satisfy the first set of preconditions, using the navigation map to determine a first route including a secondary set of steps that, when performed, produces the first target state from the first observed current state; and performing the secondary set of steps of the first route.

According to an aspect, a software testing system is provided, comprising: a navigation augmented test for software under test comprising a primary set of steps, where a first step of the primary set of steps includes a first navigation instruction specifying a first target element; a navigation map of the software under test; a processing system; and memory storing instructions that, when executed, cause the software testing system to perform operations comprising: determining a first set of preconditions associated with a first target state of the software under test where the first target element is available for interaction; determining a first set of state conditions associated with a first observed current state of the software under test; in response to determining the first set of state conditions does not satisfy the first set of preconditions, using the navigation map to determine a first route including a secondary set of steps that, when performed, produces the first target state from the first observed current state; and performing the secondary set of steps of the first route on the software under test.

According to an aspect, a computer system is provided comprising: a processing system; and memory comprising computer program instructions for performing operations comprising: performing a first step of a primary set of steps of a navigation augmented test for a software under test, wherein the first step specifies a navigation instruction to navigate to a first target element; determining a first set of preconditions associated with a first target state of the software under test where the first target element is available for interaction; determining a first set of state conditions associated with a first observed current state of the software under test; in response to a determination that the first set of state conditions does not satisfy the first set of preconditions, using a navigation map to determine a first route including a secondary set of steps that, when performed, produces the first target state from the first observed current state, wherein the navigation map built based on data collected in a random exploration testing run performed on the software under test; and performing the secondary set of steps of the first route.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more examples provided in this application are not intended to limit or restrict the scope of the invention as claimed in any way. The aspects, examples, and details provided in this application are considered sufficient to convey possession and enable others to make and use the best mode of claimed invention. The claimed invention should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the claimed invention.

We claim:

1. A method for performing a navigation augmented test for a software under test, comprising:
receiving a navigation map of the software under test;
performing a first step of a primary set of steps included in the navigation augmented test, wherein the first step specifies a first interaction with a first target element;
determining a first set of preconditions associated with a first target state of the software under test where the first interaction is available to be performed with the first target element;
determining a first set of state conditions associated with a first observed current state of the software under test;
in response to determining the first set of state conditions does not satisfy the first set of preconditions, using the navigation map to determine a first route including a secondary set of steps that, when performed, produces the first target state from the first observed current state; and
performing the secondary set of steps of the first route.

2. The method of claim 1, wherein the first step includes at least one of:
a navigation instruction specifying to navigate to the first target element; or
an action instruction specifying a first target action to perform in association with the first target element.

3. The method of claim 2, further comprising:
determining a second set of preconditions associated with a second target state of the software under test where the first target action can be performed;
determining a second set of state conditions associated with a second observed current state of the software under test;
in response to determining the second set of state conditions does not satisfy the second set of preconditions, using the navigation map to determine a second route including a secondary set of steps that, when performed, produces the second target state from the second observed current state;
performing the secondary set of steps of the second route to produce the second target state; and
performing the first target action.

4. The method of claim 1, wherein in response to determining the first set of state conditions satisfy the first set of preconditions:
identifying a second step of the primary set of steps specifying a second interaction with a second target element;
determining a second set of preconditions associated with a second target state of the software under test where the second interaction with the second target element can be performed;
in response to determining the first set of state conditions satisfies the second set of preconditions, determining the first step of the primary set of steps is redundant; and
collapsing the first step.

5. The method of claim 1, further comprising
determining the first target state cannot be produced from the first observed current state;
identifying a second step in the primary set of steps specifying a second interaction with a second target element;
determining a second set of preconditions associated with a second target state of the software under test where the second interaction is able to be performed;
in response to determining the first set of state conditions does not satisfy the second set of preconditions, using the navigation map to determine a second route including a secondary set of steps that, when performed, produces the second target state from the first observed current state;
performing the secondary set of steps of the second route; and
performing the second interaction with the second target element.

6. The method of claim 5, further comprising removing the first step from the primary set of steps.

7. The method of claim 5, further comprising tagging the first step in the primary set of steps to be removed.

8. The method of claim 1, further comprising:
identifying a set of fallback instructions;
determining at least one step of the secondary set of steps of the first route cannot be performed successfully; and
performing the set of fallback instructions to produce the first target state.

9. The method of claim 1, further comprising:
identifying a second step of the primary set of steps specifying a second interaction with a second target element;
determining a second set of preconditions associated with a second target state of the software under test where the second target element is available for the second interaction;
determining a second set of state conditions associated with a second observed current state of the software under test;
in response to determining the second set of state conditions does not satisfy the second set of preconditions, using the navigation map to determine a second route including a secondary set of steps that, when performed, produces the second target state from the second observed current state; and
performing the secondary set of steps of the second route to produce the second target state.

10. The method of claim 1, wherein determining the first set of state conditions associated with the first observed current state comprises using at least one sensor defined to collect the first set of state conditions.

11. A software testing system, comprising:
a navigation augmented test for software under test comprising a primary set of steps, where a first step of the primary set of steps includes a first navigation instruction specifying a first target element;
a navigation map of the software under test;
a processing system; and
memory storing instructions that, when executed, cause the software testing system to perform operations comprising:
determining a first set of preconditions associated with a first target state of the software under test where the first target element is available for interaction;
determining a first set of state conditions associated with a first observed current state of the software under test;
in response to determining the first set of state conditions does not satisfy the first set of preconditions, using the navigation map to determine a first route including a secondary set of steps that, when performed, produces the first target state from the first observed current state; and
performing the secondary set of steps of the first route on the software under test.

12. The software testing system of claim 11, further comprising:
identifying a second step of the primary set of steps including an action instruction specifying a first target action to perform in association with the first target element;
determining a second set of preconditions associated with a second target state of the software under test where the first target action is able to be performed;
determining a second set of state conditions associated with a second observed current state of the software under test;
in response to determining the second set of state conditions does not satisfy the second set of preconditions, using the navigation map to determine a second route including a secondary set of steps that, when performed, produces the second target state from the second observed current state;
performing the secondary set of steps of the second route to produce the second target state; and
performing the first target action.

13. The software testing system of claim 11, wherein in response to determining the first set of state conditions satisfies the first set of preconditions:
identifying a second step of the primary set of steps, wherein the second step specifies an interaction with a second target element;
determining a second set of preconditions associated with a second target state of the software under test where the interaction with the second target element is able to be performed;
in response to determining the first set of state conditions satisfies the second set of preconditions, determining the first step of the primary set of steps is redundant; and
collapsing the first step.

14. The software testing system of claim 13, further comprising:
identifying a second step of the primary set of steps specifying a first interaction with a second target element;
determining a second set of preconditions associated with a second target state of the software under test where the second target element is available for the first interaction;
determining a second set of state conditions associated with a second observed current state of the software under test;
determining the second target state cannot be produced from the second observed current state;
identifying a third step in the primary set of steps specifying a second interaction with a third target element;
determining a third set of preconditions associated with a third target state of the software under test where the third target element is available for the second interaction;
in response to determining the second set of state conditions does not satisfy the third set of preconditions, using the navigation map to determine a second route including a secondary set of steps that, when performed, produces the third target state from the second observed current state;
performing the secondary set of steps of the second route to produce the third target state; and
performing the third interaction with the third target element.

15. The software testing system of claim 14, further comprising replacing the second step in the primary set of steps with a navigation instruction specifying to navigate to the third target element.

16. A computer system comprising:
a processing system; and
memory comprising computer program instructions for performing operations comprising:
performing a first step of a primary set of steps of a navigation augmented test for a software under test, wherein the first step specifies a navigation instruction to navigate to a first target element;
determining a first set of preconditions associated with a first target state of the software under test where the first target element is available for interaction;
determining a first set of state conditions associated with a first observed current state of the software under test;
in response to a determination that the first set of state conditions does not satisfy the first set of preconditions, using a navigation map to determine a first route including a secondary set of steps that, when performed, produces the first target state from the first observed current state, wherein the navigation map built based on data collected in a random exploration testing run performed on the software under test; and
performing the secondary set of steps of the first route.

17. The computer system of claim 16, further comprising:
identifying a second step of the primary set of steps including an action instruction specifying a first target action to perform in association with the first target element;
determining a second set of preconditions associated with a second target state of the software under test where the first target action is able to be performed;
determining a second set of state conditions associated with a second observed current state of the software under test;
in response to determining the second set of state conditions does not satisfy the second set of preconditions, using the navigation map to determine a second route including a secondary set of steps that, when performed, produces the second target state from the second observed current state;
performing the secondary set of steps of the second route to produce the second target state; and
performing the first target action.

18. The computer system of claim 16, wherein in response to a determination that the first set of state conditions satisfies the first set of preconditions:
identifying a second step of the primary set of steps specifying to navigate to a second target element;
determining a second set of preconditions associated with a second target state of the software under test where the second target element is available for interaction;
in response to a determination that the first set of state conditions satisfies the second set of preconditions, determining the first step of the primary set of steps is redundant; and
collapsing the first step.

19. The computer system of claim 16, further comprising:
determining the first target state cannot be produced from the first observed current state;
identifying a second step in the primary set of steps that specifies at least one of:
a navigation instruction to navigate to a second target element; or
a first target action to perform in association with the second target element;
determining a second set of preconditions associated with a second target state of the software under test where the second step is able to be performed;
in response to determining the first set of state conditions does not satisfy the second set of preconditions, using the navigation map to determine a second route including a secondary set of steps that, when performed, produces the second target state from the first observed current state;
performing the secondary set of steps of the second route; and
performing the second step.

20. The computer system of claim 19, further comprising reporting a warning in association with performing the first step.
